(19) United States
(12) Patent Application Publication
(10) Pub. No.: US 2015/0264130 A1
(43) Pub. Date: Sep. 17, 2015

(54) Method to form a real time incident based social group

(71) Applicant: SIVA PRAKASA REDDY PAPPULA, FREMONT, CA (US)

(72) Inventor: SIVA PRAKASA REDDY PAPPULA, FREMONT, CA (US)

(21) Appl. No.: 14/217,415

(22) Filed: Mar. 17, 2014

(51) Int. Cl. H04L 29/08; H04L 12/18; G06F 17/30

(52) U.S. Cl. CPC H04L 67/1051; G06F 17/30386; H04L 12/1813

(57) ABSTRACT

A method to establish a social group in real time is provided. The method comprises collection of a user's interest information through a software application provided on the user's computing device. The method further matches the user's interest query with interest information of other users kept in the main system server. The system server then identifies various users having common interest information as that of the user and creates a social group of such users.

### CROSS-REFERENCE(S) TO RELATED APPLICATIONS

This application takes priority from U.S. provisional application No. 61/802,106 filed on 15 Mar. 2013

### TECHNICAL FIELD

This disclosure generally relates to social networking, and more particularly to formation of a social group based on real time incident happening with a user.

### BACKGROUND

The popularity and growth of social network sites and services has increased dramatically over the last few years. Existing social network sites include Facebook, Google+, Twitter, MySpace, YouTube, LinkedIn, Flicker, Jaiku, MYUBO, Bebo and the like. Such social networking sites are typically organized around user profiles and/or collections of content accessible by members of the network. Membership in such social networks is comprised of individuals, or groupings of individuals, who are generally represented by profile pages and permitted to interact as determined by the social networking service.

In many popular social networks, especially profile-focused social networks, activity centres on web pages or social spaces that enable members to communicate and share activities, interests, opinions, status updates, audio/video content, etc. across networks of contacts. Social networking services might also allow members to track certain activities of other members of the social network, collaborate, locate and connect with former acquaintances and colleagues, establish new connections with other members and share various kinds of information among its members.

While social networks are usually comprised of individuals, members might also include companies, restaurants, political parties and event profiles that are represented in a like manner to human members (e.g., profile pages accessible by members of a social network). Individual members typically connect to social networking services through existing web-based platforms via a computing device and/or mobile smartphone. Smartphone and games-based mobile social networking services are other rapidly developing areas.

Whereas, the social networks have made it easy to share information among its users, however, constantly there is a need of presenting the ever increasing information in a better way.

### SUMMARY

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

According to an embodiment of the invention a method to form a social group based on a real time incident information generated by a user is provided. The method further identifies other users having related information to the real time incident query information generated by the user and forms a group real time so as to facilitate exchange of various information.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

Reference will be made in detail to embodiments of the disclosure, non-limiting examples of which may be illustrated in the accompanying drawing figures (FIGs). The figures may be in the form of diagrams. Some elements in the figures may be exaggerated or drawn not-to-scale; others may be omitted, for illustrative clarity. Any text (legends, notes, reference numerals and the like) appearing on the drawings are incorporated by reference herein. When terms such as “left” and “right”, “top” and “bottom”, “upper” and “lower”, “inner” and “outer”, or similar terms are used in the description, they may be used to guide the reader to orientations of elements in the figures, but should be understood not to limit the apparatus being described to any particular configuration or orientation, unless otherwise specified or evident from context. Different “versions” of elements may be referenced by reference numerals having the same numbers (###) followed by a different letter suffix (such as “A”, “B”, “C”, or the like), in which case the similar elements may be inclusively referred to by the numeric portion (###) only of the reference numeral

FIG. 1 illustrates the implementation of a social group.

FIG. 2 illustrates exemplary specific entities that can be formed using the invention.

FIG. 3a illustrates the connection permissions within a social group as according to an embodiment of the invention.

FIG. 3b illustrates various derived privileges between various interconnected social groups in accordance to an embodiment of the invention

FIG. 4 depicts the various access based roles and privileges available to various categories of users.

FIG. 5 illustrates a specific example of sharing messages across interconnected social groups.

FIG. 6 depicts member to member communication within the social group for a specific entity.

FIG. 7 illustrates an individual user as a specific entity.

FIG. 8 illustrates the formation of sub entities within a social group.

FIG. 9 depicts implementation of Incident system

FIG. 9a shows the information that needs to be sharing with selected parties based on the incident severity

FIG. 9b shows the parties i.e. people that need to be already based on the incident severity

FIG. 10 illustrates an example operating environment in which the invention may function.

FIG. 11 is a schematic block diagram of a sample-computing environment

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

The embodiments and aspects thereof may be described and illustrated in conjunction with systems, devices and methods which are meant to be exemplary and illustrative, not limiting in scope. Specific configurations and details may be set forth in order to provide an understanding of the invention(s).

However, it should be apparent to one skilled in the art that the invention(s) may be practiced without some of the specific details being presented herein. Furthermore, some well-known steps or components may be described only generally, or even omitted, for the sake of illustrative clarity.

Reference herein to “one embodiment”, “an embodiment”, or similar formulations, may mean that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

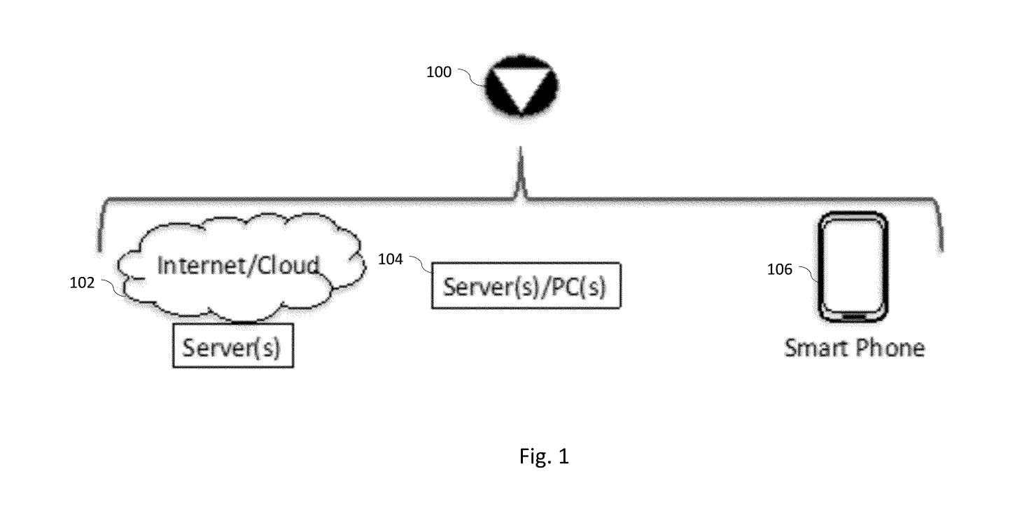

Referring to FIG. 1, which depicts the formation of a social group 100 in various ways. In one embodiment of the invention the social group 100 is implemented through a mobile device 106. This can be achieved through a mobile application on the mobile application. In furtherance to this the implementation to this embodiment can also be achieved by storing some of the content on cloud 102. The information of the social group 100 can be propagated using REST framework or JSON or XML coding.

The logic for creation of the social group 100 can also be stored in various plugins or extensions into any existing mobile applications. The implementation ca also be achieved through web based applications. For this to achieve the process is hosted on a remote server which can be accessed via various protocols such as HTTP/HTTP(s). The logic for creation of the social group 100 can also be written within the applications made for various social media platforms.

In another embodiment of the invention, the social group 100 can also be implemented through a personal computer 104.

The social group 100 however not limiting to the scope of the invention, an application software system. As described above the social group 100 can be implemented as an application running on a mobile device 106 or a personal computer 104 running as an application running on various mobile platforms such as iPhone, Android, Microsoft tablet and other types of computer systems which have given memory and ability to interact with users. The application software system residing on a main server (not shown in the figure) maintains certain information about the social group 100 which may be, however not limiting to the scope of the invention, type of the social group 100, name, certain identifiers, description, keywords, databases, files and objects, users privileges and roles, message filter rules, settings, current location of a user, location history of the user, and other information. The mobile devices 106 or the personal computer 104 can contact the main server to locate other relevant virtual specific entities and gather information about the social group 100. In some embodiments the mobile device 106 may cache various information related to the social group 100 to improve performance and responsiveness to users. Social group systems servers can be implemented as single or groups of servers with facility to back the information, distribute the load and provide high resilience against various failures. In some embodiments, the social group 100 can be created manually, by user specifying the entity details. In other embodiments, the social group 100 may be created automatically by system. For example, automatically creating a social group for all restaurants in a given area. In yet another embodiment of the invention various other social groups can be connected to the social group 100. Also, in some embodiments the social group 100 can be connected to email, web and other interfaces as well.

### Explanation for Connection Formation of Social Groups:

### Static Connection Formation:

A user may request to identify a set of relevant social groups based on certain key terms or keywords or any other information or any combination thereof. The request of the user is taken by the software application and forwarded to the main server. The main server returns to the user, results related to the query input from him. A set of social groups presented to the user after which if the user may wish he may select either one of the social groups or multiple social groups as per his interest to join. Therefore, the user may also join multiple social groups at a time.

### Dynamic Connection Formation:

As mentioned above in the description connecting to the social group 100, enables users to gather relevant information and discussion. Therefore, dynamic connection formation is provided in order to provide the user facility to find relevant information when he is on the move. This may be based on context, such as events, activities or other interests of the user. The information of the virtualized social entity system is updated so as to indicate the dynamic connections at any point of time as per the user's movement. In one embodiment of the invention the social group 100 can automatically connect to a nearby other virtualized social entities. Connection can be based on user's interest/history or through user's explicit search request. Also, optionally the connection may be automatically terminated when the user is physically away or is not active, from the virtualized social entity to which he was connected dynamically.

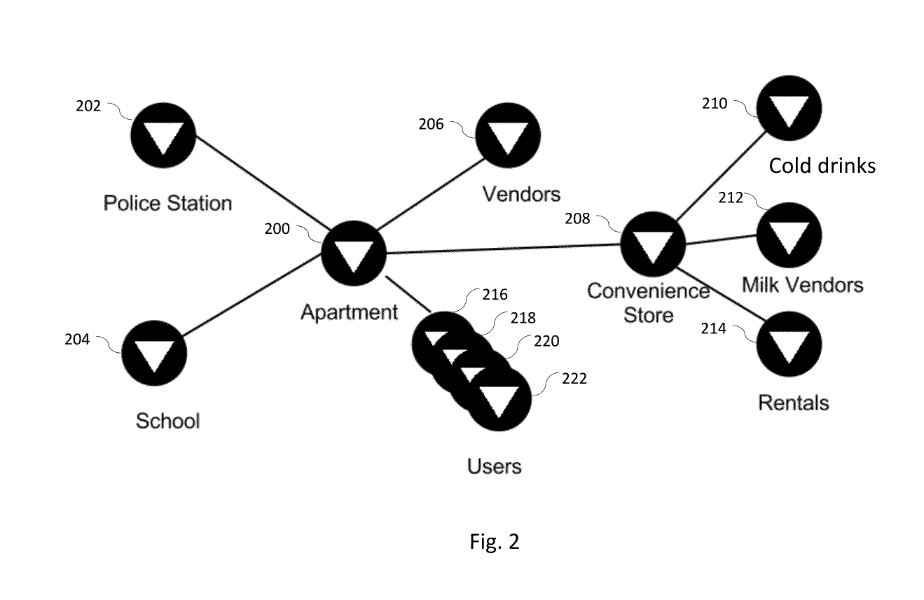

Moving onto FIG. 2, which illustrates a social group 200 connected to another social group 208 and the various services available to the users 216, 218, 220 and 222 within these connected groups. In an exemplary embodiment of the invention, however not limiting to the scope of the invention, a social group could be an apartment 200 which has further other various social groups like police station group 202, school group 204, vendors group 206 like plumber, electrician etc., convenience store group 208 which is further connected to cold drinks services group 210, milk vendors group 212, and rentals group 214 which could be video renting etc. The various users 216, 218, 220 and 222 who are connected to the apartment group 200 can access services in the groups which are connected to the apartment group 200. Hence, a facility is provided to join large number of social groups at once. In the way of example, search for social group can be done using distance as a measure i.e. list all the specific groups which are within 50 miles radius. Once the list of specific groups is returned, user can decide to join all the social groups which are retuned by the query. Social groups can be identified through various factors such as topic of interest, physical distance and other means. Once the social group is detected a request to join the social group is made. In some embodiments, this is accomplished by clicking “Join” button on the screen of a computing device or through a gesture on a touch screen device.

In another embodiment of the invention, connecting to social group helps in gathering relevant information and discussion. To support scenarios where the user is on move and wants to find relevant information based on nearby specific entities or based on context, such as events, activity or other interests, dynamic connections of specific entities is allowed. In one embodiment a given virtual specific entity automatically connects to a nearby specific entities. Optionally, when user is physically away from a dynamically connected social group without any activity then user's connection to a given social group is removed. The users connected with the social group are able to share messages which can be anyone of conversations, chats, news, information, reviews, recommendations, and, questions amongst themselves. The messages shared can be categorized as anyone, but not limiting to the scope of the invention as a global message, a shared message, or a private message.

In yet another embodiment of the invention, in cases where a forum that results into a social group does not have a true physical association i.e. there may be users from various locations of the world who want to participate in a group etc. This forum may be represented as a social group. Users associated with this social group may also be optionally organized into further sub groups with basic attributes for e.g. physical location of users, interests of users etc. Such a sub grouping enables creation of a local sub group so as to enable interaction between local users as well.

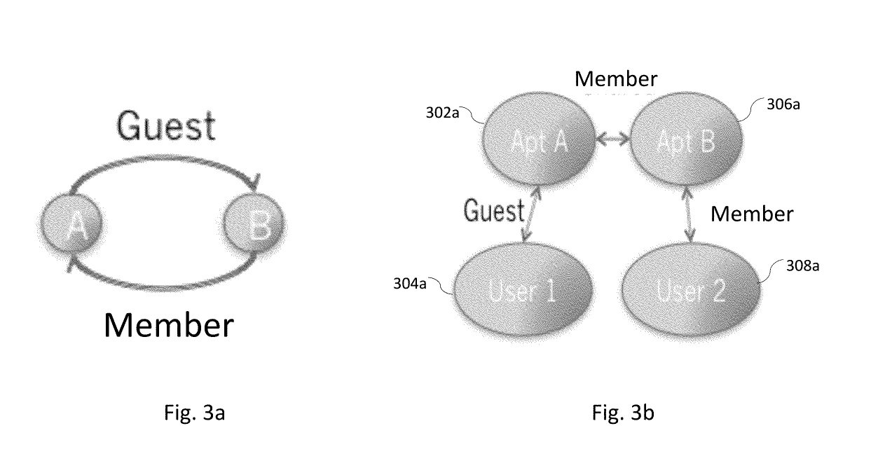

FIG. 3a illustrates the connection permissions within a social group connected to a social group. In an embodiment of the invention a social group can be formed automatically by a system or manually by a user. When a new social group is formed and is connected to another social group then, only public information is accessible by default. Through various authorization methods, other privilege levels such as a member or an owner can be obtained. In one embodiment, this is implemented by user sending an access level request to existing owners. Owner on viewing the request decides the right privilege level for the user.

In another embodiment of the invention different level of access is provided as well Specific Example: as shown in the FIG. 3a user A might have guest level permission on B, but B might have member level access to user A.

FIG. 3b illustrates various derived privileges between various interconnected social groups in accordance to an embodiment of the invention. In an embodiment of the invention Apartment A 302a (depicted as Apt A) is a social group which is connected to Apartment B (depicted as Apt B) 306a. User1 304a belongs to a social group for Apt A 302a. User2 belongs to a social group for Apt B 306a. User1 304a has guest access to Apt A 302a. User2 has member level access to Apt B. Even though Apt A and Apt B have member privilege, User1 will only get guest level access to Apt B.

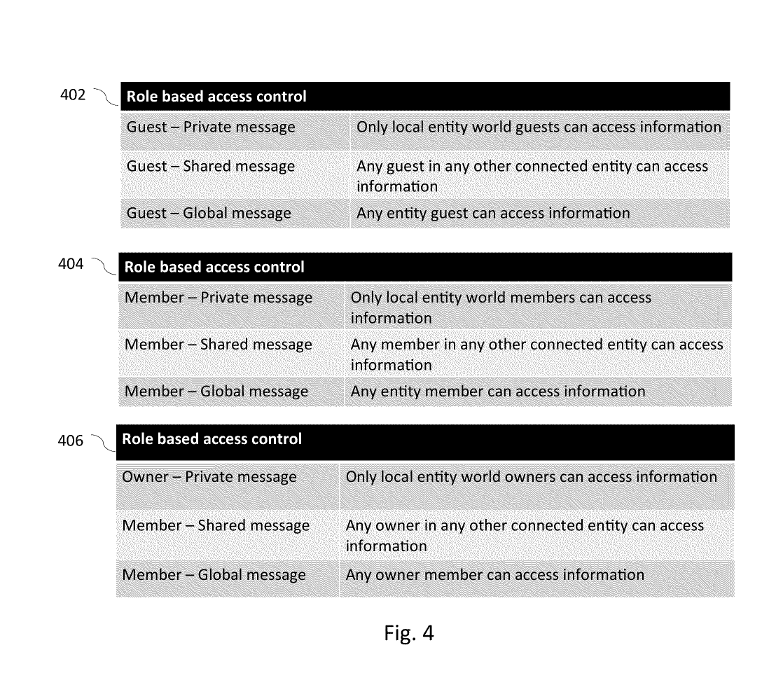

Referring to FIG. 4, it depicts tables to illustrate various types of access that can be provided to users with various types of roles. References will be made to FIG. 2 to explain the context of the invention. As shown in table 402, the role based access control for a user assigned with a guest role within the social group connected to the social group 100. As mentioned above in the description, the information posted by the user can also be further classified into various categories. As table 402 depicts when a guest user posts a private message to the social group 100, this message can be accesses by only those guest users which are connected to the social group 100. However, if the guest user posts a message classified as a shared message to the social group 100, then this message can be accessed by any guest user in any social group connected to the social group 100. Furthermore, if the guest user posts a message classified as a global message, then any guest in any social group can whether connected to the social group 100 or not, can access the message. This is because one user may be connected to multiple specific entities which might or might not be connected to each other.

Further as depicted in table 404 when a member user posts a private message to the social group 100, this message can be accesses by only those member users which are connected to the local social group 100. However, if the member user posts a message classified as a shared message to the social group 100, then this message can be accessed by any member user in any social group connected to the social group 100. Furthermore, if the member user posts a message classified as a global message, then any member in any social group can whether connected to the social group 100 or not, can access the message. This is because one user may be connected to multiple specific entities which might or might not be connected to each other.

Further as depicted in table 406 when an owner user posts a private message to the social group 100, this message can be accesses by only those owner users which are connected to the local social group 100. However, if the owner user posts a message classified as a shared message to the social group 100, then this message can be accessed by any owner user in any social group connected to the social group 100. Furthermore, if the owner user posts a message classified as a global message, then any owner in any social group can whether connected to social group 100 or not, can access the message. This is because one user may be connected to multiple social groups which might or might not be connected to each other.

In another embodiment of the invention, various roles can also be assigned to various connected social groups. For e.g. as depicted in FIG. 2 the Apartment social group 200 which is connected to Police station social group 202 can have anyone of an owner role, a guest role, or a member role.

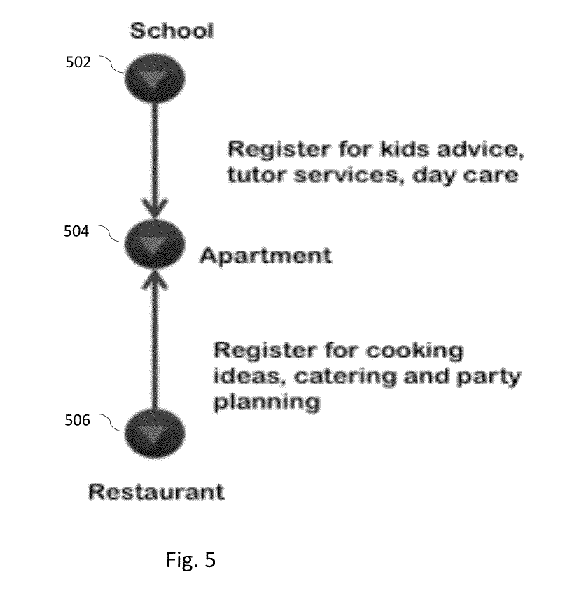

Moving further to FIG. 5, which illustrates message filtering within interconnected social groups. In an embodiment of the invention, a social group can specify set of services and interest a given social group is interested in participating. Based on this information, services and messages to connected mini-worlds are limited.

For example, as shown in the FIG. 5, a school social group 502 is connected to an apartment social group 504. The apartment social group 504 is also connected to a restaurant social group 506. According to the invention, the school specific can specify that it is interested in kids and education topics. This limits the school social group to these topics and filter any posts from coming to the school social group from the apartment social group. When a service request is made by a social group, a cyclic connect graph is constructed, using well known computer science algorithms like dijkstra's however, not limiting to the scope of the invention. In this graph message is sent only on links which have proper permission, as described by role based access control. In some embodiments facility is provided for message propagation speeds. For e.g. traverse up to 5 connected worlds per day or post it to communities within 50 miles.

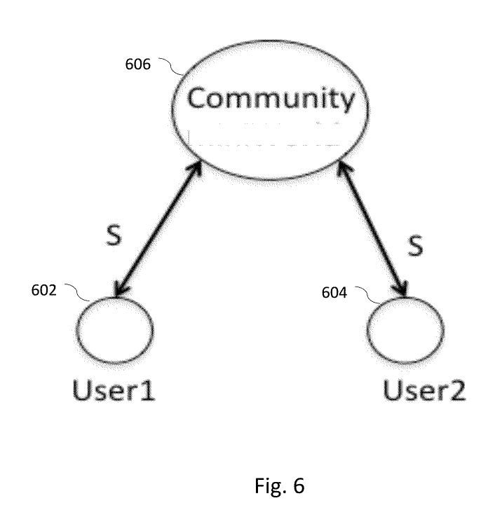

FIG. 6 illustrates a specific member to member communication as per one embodiment of the invention. As shown in the FIG. 6 two member User1 602 and User2 604 are connected to a community social group 606. If the users 602 and 604 are not directly connected to each other, then each user can only see public information of other user. Only after connecting with that user, information with shared or owner level privilege might be accessible. Two users who are not connected via any graph will not be able to reach directly. However, paid service, or by requesting permission from connecting set of social group in a graph is allowed. For e.g. If User1 602 who is not directly connected to User2 604 can request to view User1's 602 information by paying certain amount to community social group 606 to which both User1 602 and User2 604 are connected. To request for User1's 602 details the User2 604 might be required to register himself. This can be done by filing up of an electronic form by the User2 604, to register himself to the social group 606.

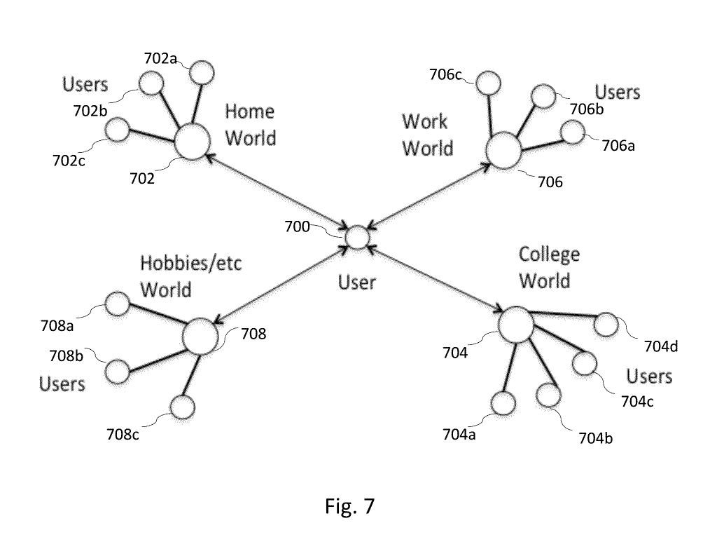

Referring to FIG. 7, as per another embodiment of the invention an individual 700 can also be a social group. In a real group user might end up with set of groups. For example, home 702, work 706, college 704, Hobbies/play 708 etc. A User will have friends, family and acquaintances at each group. In an embodiment of the invention the user 700 can post a specific message to his work group 706 which will be only accessible to users 706a. 706b, and 706c connected to the user 700 through his work group 706. Similarly the user can post a specific message to his Hobbies group 708 which will only be accessible to users 708a, 708b, and 708c connected to the user 700 through his Hobbies group 708. Further, the users 704a, 704b, 704c, and 704d can also see those posts which the user 700 posts to his college group 704. Also, the users 702a, 702b, and 702c can also see those posts which the user 700 posts to his Home group 702.

This setting allows the user 700 to post message to a selected communities to limit the scope of a given information. In addition, system automatically creates set of useful lists, such as all friends, family, friends at home, friends at work, professional network and the like. This enables the user 700 to be selective and share information with these communities. User 700 can use traditional methods such as email to post information to these communities as well.

However, in another embodiment of the invention the user 700 can also decide to share some information between more than one connected groups. For e.g. he may share come information with both the home group 702 and the college group 704 simultaneously.

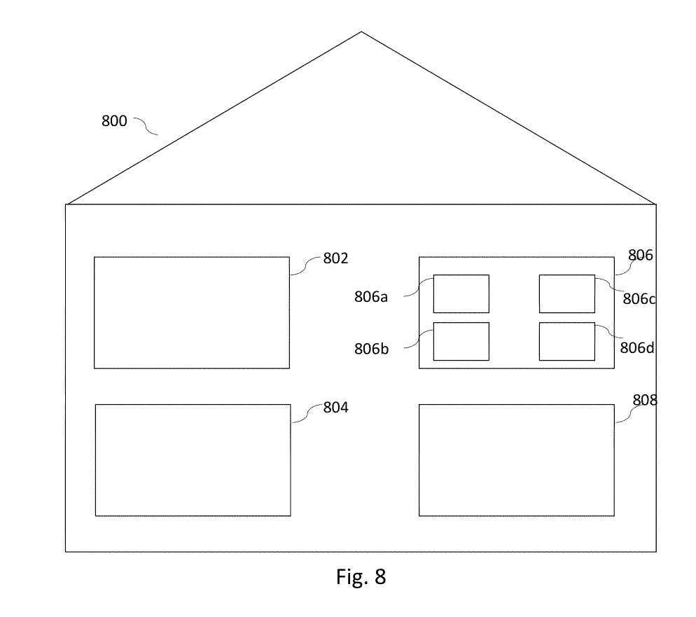

Moving further to FIG. 8 which illustrates formation of various sub groups 802, 804, 806, and 808 within a social group 800. In an embodiment of the invention however, not limiting to the scope of the invention, a social group 800 can be a shopping mall. Since a shopping mall may comprise of many shops hence the mall entity 800 spanning entire mall may not meet the needs of visiting users. Hence, various smaller virtualized sub entities are created for individual stores, brands, etc. within the virtualized mall group 800. In an embodiment, the virtualized mall entity 800 can be further divided into a pharmacy sub group 802, a Daily needs sub group 804, an office supplies group 808, and an electronics sub group 806. In an another embodiment of the invention the electronics sub group can also be further divided into various sub groups like laptops sub group 806a, a washing machine sub group 806b, a television sub group 806c, and a mobile phone sub group 806d.

### Incident Based Group:

Several embodiments of the invention provide facilities for communicating with different entities in case of various incidents. For example, when an incident occur through various facilities described in the invention varies parties such as nearby communities, volunteers, public safety facilities, users friends and family can be notified quickly. Thus providing a faster method to get the effected users help in case of various emergency situations.

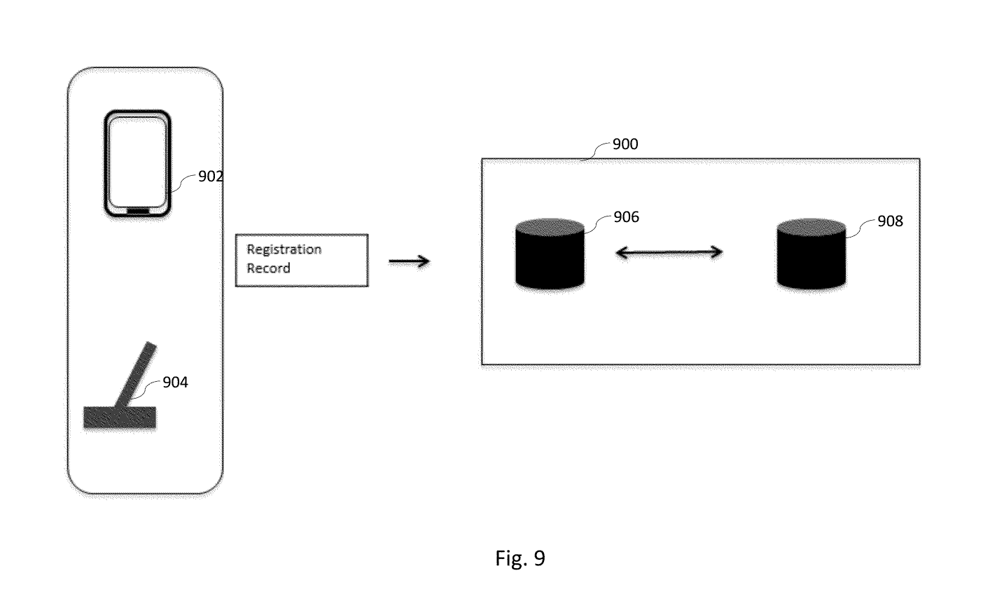

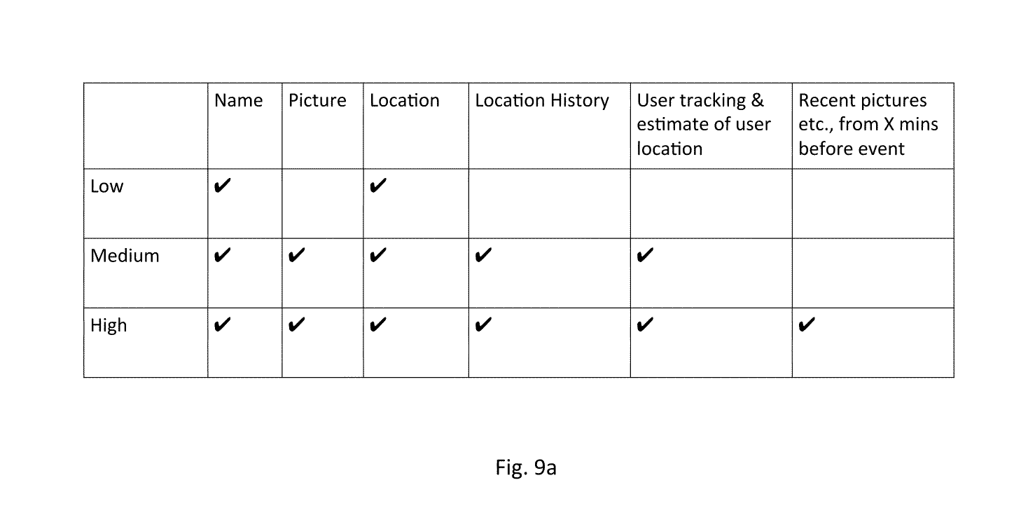

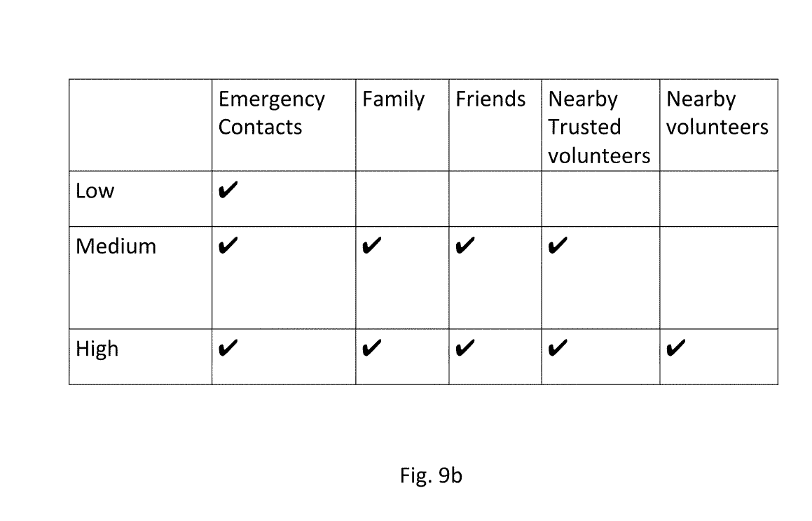

According to an embodiment of the invention a user can register himself as a volunteer with an incident system 900 to register various services they want to offer to other users in need. Referring to FIG. 9 which illustrates the incident system 900. The user can register with this system through his computing device 902 or 904. The computing device can be however, not limiting to the scope of the invention a mobile device, a laptop, a personal computer, a personal digital assistant, a tablet, or a car's system. Further, the incident system 900 contains a registration server 906. The registration server 906 stores information of various users and links it to a social group server 908.

In another embodiment of the invention a user of the Incident system 900 can register with Incident system 900 information that can be exchanged with various parties when an incident occurs. For example, as shown in FIG. 9a the table shows information that needs to be shared based on incident severity level. FIG. 9b shows set of users that need to be notified based on incident severity. In some embodiments user can also specify different options based on incident type. In addition in some embodiments user can also specify how the information should be shared at individual user level.

### Pre-Incedent Support

In some cases user might want to feel secure, so might need assistance from others to gain the confidence. Several embodiments are suggested to provide that support. In one embodiment, a user on travel can solicit volunteers who are traveling say to the same destination. Facilities are provided to post message to volunteers about the request to accompany the user for a given route via PC or mobile devices through IM, SMS, MMS, email and other facilities. Volunteer can see the user request and associated profile. Once the volunteer agrees the request is send back to the sender.

In other embodiment a user can register for paid for security service, such as security escort, travel companion and like. Facilities are provided for the security provider to register a physical area which enables the user to locate such services easily.

In another embodiment, security personnel and other users can subscribe to the security service. This enables users in that social group to locate and communicate with the personnel easily. For example, even if there are two security personnel, on clicking to call a given security personal, Incident system 900 can maintain which security person is on site and direct the call to them. When more than one security personnel are available, information such as text message and like can be sent to the whole group. For example, in a train people traveling can connect with Police officers, Drivers, Ticket master etc., very easily. Similarly, in flight users can maintain communication with airhostess, pilot, and, security officers on board. This has added advantage that users can communicate threat information without getting noticed by malicious users.

In some embodiments a given user can actively share user's whereabouts to selective audience. This helps in detection of any incident quickly.

In some embodiments, during travel to non-native countries user can link to respective embassies social group security personnel using this method. This way user can feel secure while in a new and unknown country.

In some embodiments user can connect with locals to seek their helps. Various facilities are provided to share points or pay by current for the service.

Modern vehicles (car, boats, trains, etc.,) are equipped with modern computer and communication systems. Such systems provide touch screen interface, voice based interactions, Bluetooth and other interfaces. In such systems, either directly or through linkup of vechicle to smart phone type of devices, user gets updates about incidents that occur. In some embodiments this information is shown on the vechicle's GUI system. In some embodiment this information is read via the vechicles voice system.

One of the benefits of miniWorld is it promotes interactions. Users at various communities can register as volunteers for various incidents, subject matter experts for some topics, other options are possible as well. For example, in one embodiment user can register for following set of volunteer activates:

Volunteer Security: Participates in neighborhood watch, helps to act as first responder in case of help is requested
Volunteer Medical: helps to act as first responder and/or when relevant help is needed
Volunteer First Aid: can provide first aid help
Volunteer Fire: can provide help with fire or knows the knowledge as to what to do
Volunteer Transportation: Provides transportation serves and help when requested
This registration enables users to easily locate persons offering services very easily.

Through private intent world user can register their needs i.e. need for travel companion etc. Private intent system ensures that information is not shared with any one. Through the crietria's specified by user match is made by system. After reciver reviews the high level details about the person who can offer service, additional communication can occur to accept the service. For example, a requester requesting travel companion can share the request with intent system. User can also specify additional criteria such, but not limited, stating that person should be some one whom he or she knows of Requester can review public details of the possible match candidate. Both parties can exchange additional information to proceed.

### Business Aspects

Professional security group might register for various pre-incident support, such as accompanying a user and providing various security service. Through this facility security professional can bid to show their ad in incident miniWorld.

For providing support various volunteers can be assigned points and trustworthness.

### Incedent Support

When incident occur, either the user or someone who is able to communicate can notify the incident system 900 through their computing devices. The computing devices can be however, not limiting to the scope of the invention, a mobile device, laptop, a personal computer, a personal digital assistant, or a car's system. In some embodiments options are also provided to dial an emergency phone number, and enter a PIN associated with user account. Automated system can extract information by getting user response to various questions.

As users might be in different situations during an incident, to make it easy to report the incident, user is given option to click the visible buttons on the portable devices such as volume, control and other buttons for some duration of time. In some embodiments, this automatically opens the incident reporting application. In some embodiments incident-reporting application is also provided through click.

Modern vehicles (car, boats, trains, etc.,) are equipped with modern computer and communication systems. Such system provide touch screen interface, voice based interactions, Bluetooth and other interfaces. In such systems, either directly or via linkup of phone ability is provided to create incident by either click of button, or via vechicle's voice system. In some vechicle linking up smart phone to vechicle is possible. In such systems through vechicle's voice system or through vechicle's GUI user can interact with application running on the mobile device to report incidents.

### Business Aspects:

In addition to government facilities user can register with vendors who offering security services. They can be notified to respond during such events.

### Post Incedent Support

In some embodiments once the system detect the event, it lookup the user information in the database to get user settings based on the incident type, severity and other configuration user has specified. In some embodiments incident group is created to help coordinate the incident with different volunteers. In some embodiments users are notified about the incident. As specified in user configuration various information is shared with group of volunteers. As potentially incident data is sensitive, in some embodiments options are provided to ensure that user is not able to access the information after the incident. Facilities are provided to extract information through user or legal guardians/heirs approval as may be required by various laws.

In some embodiments various facilities are provided to capture relevant information from the effected users. For example, FIG. 9a shows that user current location, recent location history, and in addition ability to track current location are provided. In addition facilities are provided to gather recently media events such as photos, video and others which might also be helpful in various situations.

In some embodiments, based on incident type and user setting, nearby users and communities are also notified. This helps in dealing with situations which are of potentially public hazard. For e.g. Debris on road etc., Users get alerted, so that they can take necessary precautionary actions to protect themselves and others.

In some embodiments News media can register to get information about various incidents. In such embodiments News media is notified on occurrence of the incident. On incident occurrence news media is notified. In some embodiments incident information is propagated to various news agencies. In some embodiments news media and other can be charged per registration to incident system.

In some embodiments to encourage volunteer participation rewards are awarded for various users. Rewards are assigned in terms of physical money or by assigning virtual points and medals.

In some embodiments once the incident is detected event world is created for it to help with coordination

### Business Aspects:

In one embodiment, incident alerting can be offered as paid for services to users, media, government as an alternative to exiting infrastrute.

### Volunteer Trust Building:

As during incident a given user is seeking help from potentially unknown persons, level of trust may not be there. In one embodiment users trust level is estimated and updated by following exemplary method:

Each user has two Trust metrics: Personal and Global. Personal trust level is based on social relationships. For example. User A is related to User B so, there is personal trust. This factor is updated from knowledge of user's social network such as, but not limited to, the social group 100. In accordance with user's profile, if the user is connected to set of places a user has worked or lived, then Global Trust level is updated based Trust level of place of work and location of work.

In addition global trust factor is updated based on the reviews user receives. Trust level is also build by verification of user location by using portable media devices. Facilities are provided to continuously track user for long period of time to establish user's validity about location of home, work, etc.

In some embodiments a social graph of users is compared to the travel social group. If a common user is detected then it is highlighted. In addition list of users in the travel social group is organized by trust. This enables user to locate the user with highest trust level quickly.

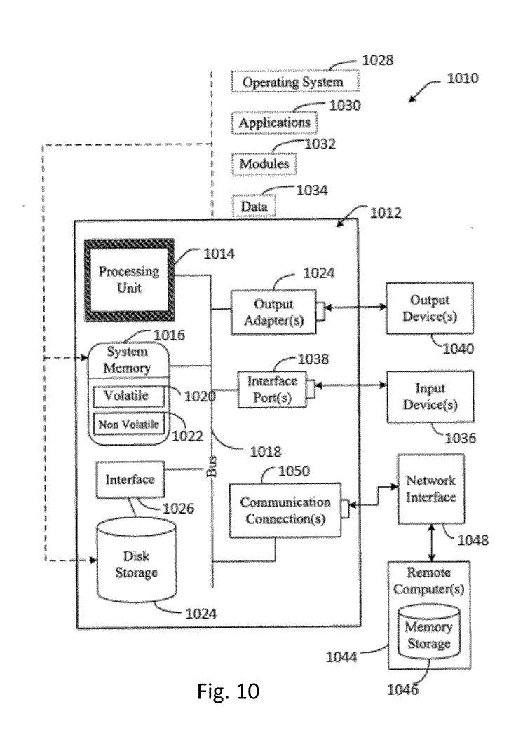

With reference to FIG. 10, an exemplary environment 1010 for implementing various aspects of the subject invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethemet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

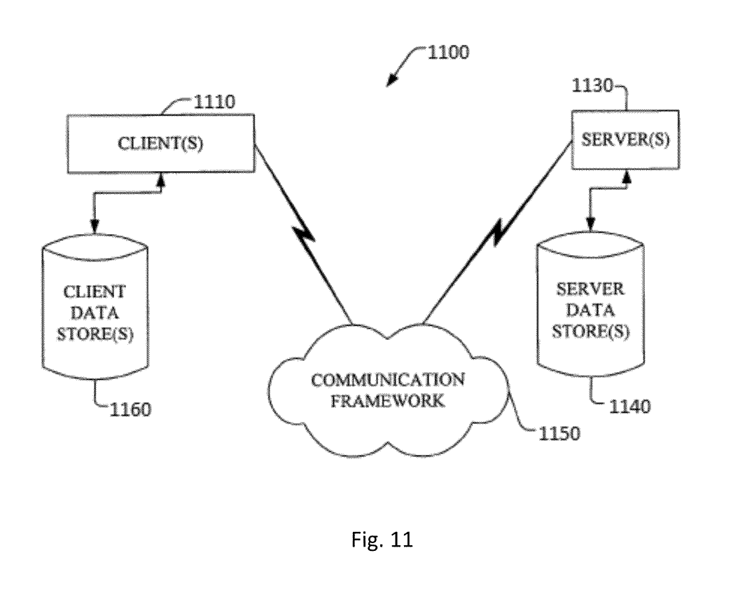

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of establishing a social group, the method comprising:
collecting information about a real time intent from an initiating user through a computing device of the initiating user;
comparing the real time intent information of the initiating user with real time intent information of plurality of other users collected through their respective computing devices, wherein the computing device of the initiating user and the various users are connected through a network;
identifying a set of users having a common real time intent information between as to that of the initiating user; and
forming the social group dynamically based on the common real time intent information with the initiating user and the set of other users as members of the social group.

2. The method of claim 1, wherein the members are able to post information to the social group.

3. The method of claim 2, wherein the information is posted via anyone of a mobile device, a personal computer, a tablet computer, a wireless computer, or a personal digital assistant.

4. The method of claim 1, wherein the members are able to discover other users or social groups based on their real time intent information dynamically.

5. The method of claim 1, wherein the social group is formed on basis of geographic location of the initiating user.

6. The method of claim 1, the initiating user is able to communicate real time with the set of users connected to the social group.
